(19) United States
(12) Patent Application Publication
(10) Pub. No.: US 2003/0218549 A1
(43) Pub. Date: Nov. 27, 2003

(54) Powerline communications system for providing multiple services to isolated power generating plants

(76) Inventors: Oleg Logvinov, East Brunswick, NJ (US); Lawrence F. Durfee, Washington, NJ (US); Brion Ebert, Easton, PA (US)

Correspondence Address: NORRIS MCLAUGHLIN & MARCUS, P.A., P O BOX 1018, SOMERVILLE, NJ, 08876

(21) Appl. No.: 10/423,787

(22) Filed: Apr. 25, 2003

Related U.S. Application Data
(60) Provisional application No. 60/376,122, filed on Apr. 26, 2002.

(51) Int. Cl. H04M 11/04; H04Q 9/00; G08C 19/22

(52) U.S. Cl. 340/870.07; 340/310.01

(57) ABSTRACT

Power line communications (“PLC”) technology components are included within a remote, isolated electric power generating system to provide that a single facility supplies electric power and high speed, broadband data communications access services over the same electric power network. The costs of deploying high speed, broadband data communications services in a remote, isolated community are reduced because minimal additional hardware and maintenance operations are required. The PLC technology permits a service provider to monitor and control electric power plant operating and security conditions and to obtain customer billing information concerning electric power consumption and high speed, broadband access services usage from a remote location via broadband data communication signals exchanged with the plant, thereby reducing operating costs and improving operating efficiencies.

### CROSS REFERENCE TO RELATED APPLICATION

This application claims the benefit of U.S. Provisional Application No. 60/376,122 filed Apr. 26, 2002, which is incorporated by reference herein.

### FIELD OF THE INVENTION

This invention relates to the field of data communications over conventional utility electric power conveying media, and more particularly to providing high speed, broadband data communications access services over a conventional electric power line network of a remote, isolated electric power generating system and utilizing the broadband access services to operate and maintain components of the isolated electric power generating system.

### BACKGROUND OF THE INVENTION

In many parts of the world, small communities have been and continue to be settled in locations that are remote and isolated from a main population center. Oftentimes, an isolated power generating system, which includes a power line network extending from an electric power generating plant that is located near or within the community, is the electric power source for the community.

These small, remote, isolated communities, however, usually lack a central facility that provides high speed, broadband data communications services, such as, for example, high speed Internet access services. The installation and maintenance costs of traditional wired, high speed, broadband data communications systems, such as Ethernet and DSL based communications systems, are typically too high to make it economically feasible for a broadband service provider to deploy such wire or cable based systems in these small communities. Likewise, the installation and maintenance costs associated with obtaining individual high speed, broadband satellite, wireless or dedicated wired link based data communications services are also very high. Consequently, as a practical matter, high speed, broadband data communications services are available only to the few wealthy individuals in small, isolated, remote communities.

In addition, the isolated electric power generating system, or power microgrid, serving a remote community is often a part of a larger electric power operations system or distribution grid that manages and contains a number of microgrids. In many cases, the microgrids may exist as completely isolated entities. The microgrids of the larger power grid are intentionally isolated from one another to provide power stability in the event of system wide problems in the larger power grid. For each of the microgrids, however, there is a substantial cost associated with monitoring the operating status of power plant and power line network equipment, maintaining and replacing equipment and securing the equipment against the natural and human environment. The high maintenance cost is based, in part, on the need to employ personnel at, and have personnel frequently visit, the community to perform various maintenance tasks at the power plant and on the power line network equipment. Furthermore, in many circumstances, an expensive communications channel link, such as a bi-directional satellite link, often must be installed in the microgrid to effectuate proper monitoring and control of the isolated microgrid from a distant location. Thus, the costs of initially installing and then subsequently operating and maintaining a single or several microgrids of a larger power grid, a remote stand-alone microgrid, or a plurality of stand-alone microgids oftentimes are so burdensome on an electric power service provider that it is not economically feasible to initially build and then operate and maintain a power microgrid in each remote community that desires electrical power services.

Therefore, there exists a need for system and method to provide high speed, broadband data communications access services to small, remote, isolated communities at relatively low cost and with relative ease. Further, there exists a need to reduce the effective cost of initially installing and subsequently operating and maintaining a remote, isolated electric power generating system, such that it is economically feasible to deploy such systems in small, remote, isolated communities, as may be desired.

### SUMMARY

In accordance with the present invention, a power line communications (“PLC”) system is coupled to an electric power generating source of a remote, isolated electric power generating system to provide that the electric power source, which is for supplying electric power to users over an electric power line network (“microgrid”) of the power generating system, also can supply high speed, broadband data communications access services to the users over the same power line network. Conventional utility electric power lines and wires of the power line network constitute the medium for conveying the high speed, broadband communications signals. The broadband access services are made available within a small, isolated, remote community simply by installing broadband access service PLC equipment at the power generating source and PLC data communications equipment at the locations of the power network users. As electric power and broadband communications services are supplied over the same medium, i.e., the power line network, the problems and high costs associated with the deployment of conventional wired, broadband access service systems in a small, isolated, remote community are avoided. In addition, the installation of broadband access service PLC equipment, which includes conventional PLC signal processing equipment modified to provide broadband access services on a power line network in accordance with the present invention, at the same location as the power generating source equipment, and potentially within the same housing and enclosure structures associated with power generation and distribution already existing at the power source, provides additional installation, equipment, maintenance cost savings as well as added security and safety. Further, the use of PLC technology to deploy the broadband access services adds little, if any, to the maintenance requirements of the power generating system. Thus, the power generating source of the power generating system is converted into a single point source of high speed, broadband data communications access and electric power distribution services at a relatively low additional cost and with relative ease in accordance with the present invention.

In a preferred embodiment, a PLC head end broadband access data communications system is installed at an electric power plant of a remote, isolated electric power generating system. The PLC head end system includes broadband uplink equipment, such as wireless, satellite, etc., uplink connection equipment, a broadband PLC head end controller, a PLC transceiver and a PLC power line coupler. The broadband uplink apparatus is the connection point at the power plant for external high speed, broadband access services, which may be obtained from a wireless network, such as a satellite network, or a wired network, such as an optical network, or suitable combinations thereof. A PLC gateway transceiver at an electric power user facility, e.g., a residential home or office, establishes the data communications connection between the power network user and the power line network. The PLC power line coupler at the plant facilitates exchange of high speed, broadband data communications signals, which can include high speed, broadband access services, between the PLC transceiver at the power plant and the power users over the power line network.

In a further preferred embodiment, the PLC head end system includes an electric power plant and broadband data service monitoring, command and control apparatus (“MCC”) that is coupled to the PLC head end controller. The MCC, which includes a processor and memory, collects and stores data representative of the transfer of broadband data signals to and from users. In addition, the MCC collects and stores plant operating status data based on information detected at meters, gauges and other power generation monitoring components strategically located within, or in association with, the electric power generating system.

In a preferred embodiment, PLC network monitoring devices are installed at or coupled to electric power distribution elements, such as at power transmission lines and transformers, of the microgrid. Each of the PLC network monitoring devices includes PLC signal and data processing capabilities, which are implemented in the physical layer interface and are associated with establishing power line communications. The PLC signal processing capabilities permit the PLC network monitoring device to perform power network monitoring and quality assessment functions which can include, for example, monitoring of the network for high frequency harmonics, impedance, impulse response signatures, etc. The PLC network monitoring devices transmit such network monitoring and assessment information to the PLC head end system, over the power line network, and the MCC stores such network monitoring and assessment information. The network monitoring and assessment information can be used to diagnose early stages of equipment failure or malfunction in power line system elements, and also can be transmitted from the PLC head end system to an external location.

In a further preferred embodiment, an intelligent power load sharing and PLC switch having power load sharing and power line communications functionalities is coupled to neighboring microgrids of a larger power grid network. The intelligent power load sharing and PLC switch, which includes a conventional PLC bypass apparatus, provides for network monitoring of the neighboring microgrids, regardless of whether the neighboring networks are actually electrically connected to each other to provide for electric power load sharing.

In a preferred embodiment, the PLC controller transmits, through the broadband uplink apparatus, broadband data communications signals to locations distant from the isolated community, such as to a processing unit of an operations center or the email address of the energy service provider over the Internet. These uplink signal transmissions can include the data stored at the MCC, such as data collected from within the power plant and data transmitted to the PLC head end system from a PLC gateway transceiver and a PLC network monitoring device. Further, these uplink signal transmission are performed automatically, or based on a broadband communications request for data signal that originates at the service provider's broadband connection and is received at the broadband uplink apparatus at the plant. The deployment of a PLC broadband access services system in the remote community, thus, permits the service provider to remotely retrieve information concerning plant operating status, as well as broadband access services usage by a user, as desired and with relative ease.

In a further preferred embodiment, a PLC power demand meter is coupled to a power meter within a user facility and also to the user PLC gateway. The PLC meter collects and stores power consumption information for the user facility. Preferably, the MCC automatically retrieves the power consumption information from the PLC meter, via the PLC gateway at a user facility, through the use of broadband communication signals conveyed between the user facility and the power plant over the power line network. The MCC processes and suitably stores the retrieved power consumption in a customer billing memory. Such power consumption information can be accessed from an external location upon request, or automatically transmitted to an external location, through the broadband connection apparatus.

In a further preferred embodiment, power line network fault detection equipment is coupled to the power line network at the plant and also to the MCC. The MCC controls the operation of the fault equipment, which can use PLC data communications or other electrical signals to detect the existence and location of faults, if any, in the power line network. The MCC collects and stores in its memory data representative of the detected faults. The fault detection data also can be accessed from an external location, or automatically transmitted, through the broadband connection apparatus.

In another preferred embodiment, the MMC controls user utilization of broadband access services automatically, or based on instructions from the service provider carried on broadband communications signals received at the broadband connection apparatus.

In another preferred embodiment, the MMC transmits PLC power equipment control signals on the power line network to PLC gateway transceivers at respective power user facilities to selectively control power consumption from the network so as to optimize and reduce overall power consumption.

### BRIEF DESCRIPTION OF THE DRAWINGS

Other objects and advantages of the present invention will be apparent from the following detailed description of the presently preferred embodiments, which description should be considered in conjunction with the accompanying drawings in which:

FIG. 1 is a block diagram of a preferred embodiment of an electric power and high speed, broadband data communications services system including a PLC head end broadband data communications service system coupled to a remote, isolated electric power generating system in accordance with the present invention.

FIG. 2 is a block diagram of a preferred embodiment of a PLC head end system of the electric power and broadband services system of FIG. 1 in accordance with the present invention.

FIG. 3 is a block diagram of a preferred embodiment of the user facility of the electric power and broadband services system of FIG. 1 in accordance with the present invention.

FIG. 4 is a block diagram of a preferred embodiment of a large grid power distribution network including a plurality of isolated power generating systems and power load sharing and PLC switching apparatuses coupled to neighboring isolated power generating systems.

### DETAILED DESCRIPTION OF THE INVENTION

In accordance with the present invention, high speed, broadband PLC technology is implemented in connection with a remote, isolated electric power generating system, which includes a power line network extending from a power generating plant, to provide for low cost deployment of broadband data communications access services in a remote, isolated community that depends on the remote power generating system for its energy needs. The use of a power line network as a PLC network to provide broadband access services to a facility, e.g., a residential home, business, or a wireless hot-spot, etc., located within a remote, isolated community achieves substantial cost saving advantages over the use of other traditional forms of broadband communications access service systems. For a remote community that already has a power line network in place, or for a planned remote community, the deployment of a PLC broadband access service system in the community avoids the cost of installing cabling hardware associated with conventional wired, high speed, broadband access systems, such as DSL, Ethernet or optical signal based systems. Installation cost savings are obtained because systems other than a PLC broadband access system require that a medium other than conventional electric power cables and lines be utilized for data communications. The deployment of a broadband access system that requires cabling equipment other than conventional electric power lines and wiring involves high installation costs and also the additional costs to maintain the separate cabling of such systems. Thus, the present invention advantageously makes high speed, broadband access services readily available in a small, isolated, remote community because the cost of adding high speed, broadband access service functionality to a remote, isolated electrical power generating system is relatively low. In addition, the ability to provide multiple services from a single source, i.e., the electric power plant, subsidizes the costs associated with providing the multiple services.

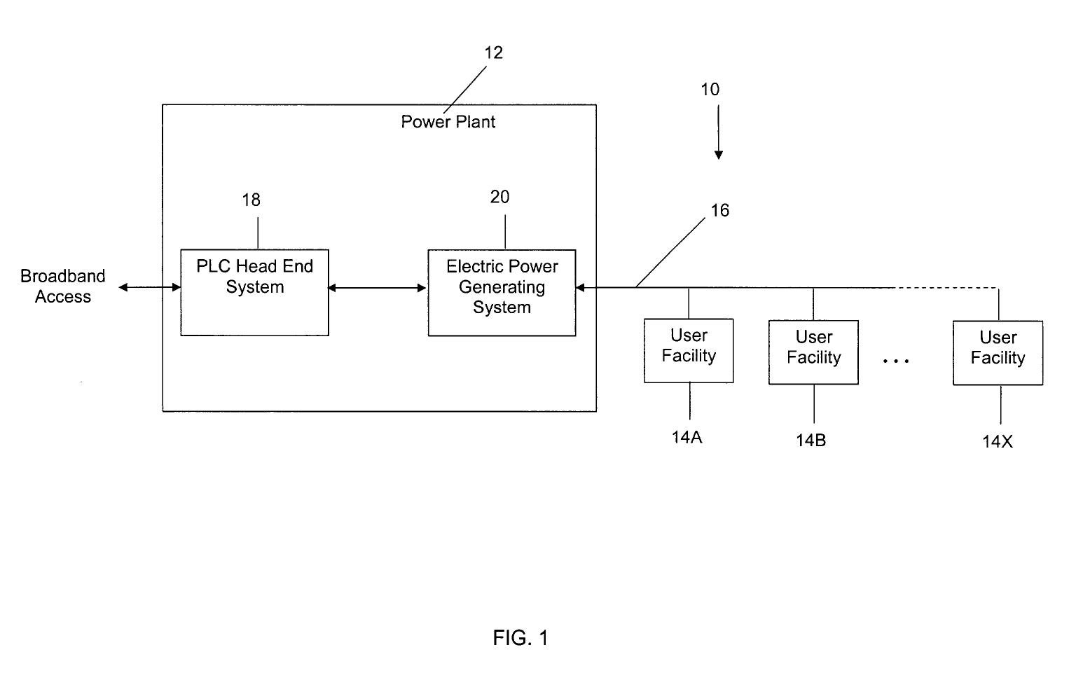

FIG. 1 is an electric power and high speed, broadband data communications services system 10 in accordance with a preferred embodiment of the present invention. Referring to FIG. 1, the system 10 includes an isolated, remote electric power generating plant 12 coupled to a plurality of power network user facilities 14A, 14B, . . . 14X over an isolated electric power network 16. The power plant 12 includes a PLC head end system 18 that is coupled to an electric power generating system 20.

The power network 16 is an isolated power line network (“microgrid”) including conventional electric power conveying media, such as outdoor power lines and transformers as well as the electric power wires that are typically installed within a user facility.

In a preferred embodiment, the power generating system 20 is a conventional, electric power generating plant that converts natural gas or fossil fuel into electric power. Alternatively, the power generating system 20 is a portable or alternative energy source, such as a wind or solar power generator or a hydroturbine. In addition, the system 20 can include EMI/RFI filtering, as suitable.

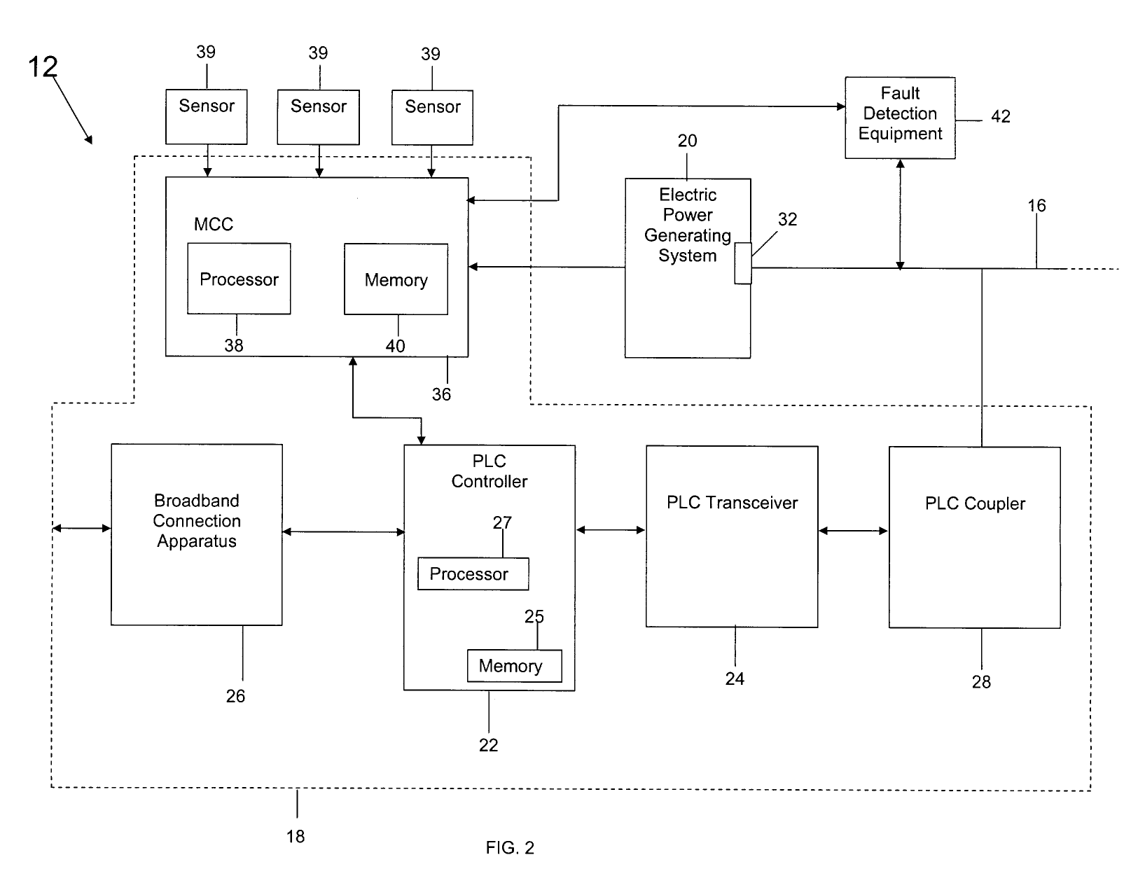

Referring to FIG. 2, which illustrates a preferred embodiment of the PLC head end system 18 within the plant 12, the PLC head end system 18 includes a PLC head end controller 22 containing a memory 25 and a processor 27. The PLC controller is coupled to a PLC transceiver 24 and a broadband uplink connection apparatus 26 over conventional electrical signal conveying cables.

The system 18 further includes a PLC power line coupler 28 that couples the PLC transceiver 24 to the power line network 16. The electric power system 20 includes an electric power supply port 32 that is coupled to the power line network 16 and the PLC coupler 28.

The PLC system 18 also includes an electric power plant and broadband data access service monitoring, command and control apparatus 36 (“MCC”). The MCC 36 includes a processor 38 and a memory 40, and is coupled to electronic sensors (not shown) within the power generating system 20 and other conventional electronic maintenance and security sensors 39, such as a video camera, strategically located throughout the plant 12. In addition, power line fault detection equipment 42 is coupled to the power line network 16 at the port 32 and to the MCC 36. It is to be understood that the the MCC 36, the PLC Controller 22, the broadband uplink apparatus 26 and the PLC transceiver 24 are shown as separate functional blocks for purposes of illustration and each includes software, hardware or a combination of hardware and software. In a preferred embodiment, a single, high speed microprocessor performs all or substantially all or all of the functions that the MCC 36, the PLC Controller 22, the broadband uplink apparatus 26 and the PLC transceiver 24 perform through a simple resource sharing mechanism.

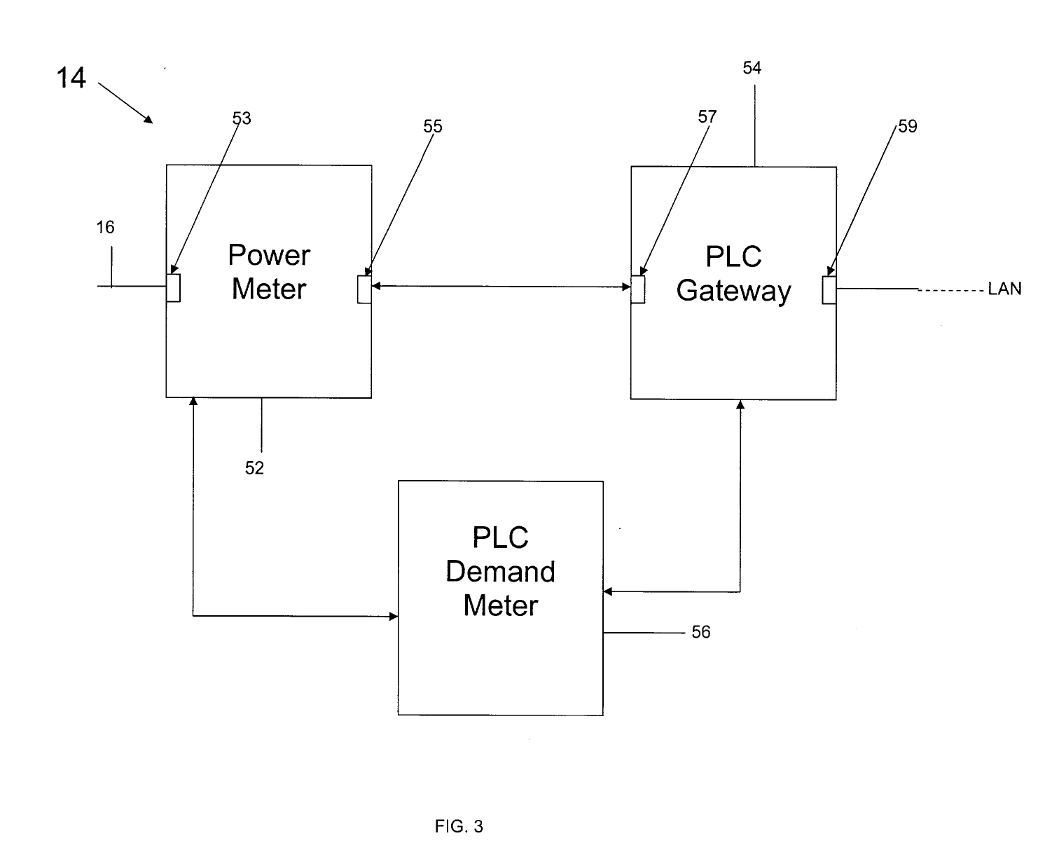

Referring to FIG. 3, which illustrates a preferred embodiment of electric power system and PLC components at the user facility 14A, the facility 14A includes a power meter 52 having ports 53 and 55. The port 53 is connected to the portion of the power line network 16 that enters the user facility 14A. The port 55 is connected to the portion of the network 16 extending into the user facility 14A, i.e., the electrical wiring within the facility. The user facility 14A also includes a PLC gateway transceiver 54 having ports 57 and 59. The port 57, which is a conventional electrical plug, is connected to any portion of, i.e., to any conventional electrical outlet that is coupled to, the network 16 within the user facility 14A. The port 59 is for connection to a high speed, broadband data communications port of a communications network device, such as a LAN router, bridge or a suitable input port of a personal computer. In addition, the user facility 14A includes a PLC power demand meter 56 coupled to the power meter 52 and the PLC gateway 54.

Referring to FIG. 2, the broadband connection apparatus 26 is a conventional, well known network termination for interconnecting a carrier signal network architecture, such as an optical, satellite or wireless network, to electrical signal conveying cables. In a preferred embodiment, the broadband apparatus 26 includes at least one of a well known, prior art radio frequency (“RF”) signal transceiver, an optical signal transceiver and a high speed (DSL or cable) modem, as well as the associated signal processing components. In a preferred embodiment, the apparatus 26 includes conventional RF or optical signal apparatus capable of receiving, downconverting and then demodulating the downconverted RF or optical carrier signals to extract the broadband data signals carried thereon. Further, such conventional RF or optical signal apparatus modulates high speed, broadband data signals onto a carrier signal, upconvert the carrier signal to RF or optical frequency and transmit the data signal modulated RF or optical signal over the appropriate medium, as suitable.

The PLC controller 22, PLC transceiver 24 and the PLC coupler 28 are conventional PLC components, such as described, for example, in U.S. patent application Ser. Nos. 10/211,033, filed Aug. 2, 2002 and 10/309,567, filed Dec. 4, 2002, each of which is assigned to the assignee of this application and incorporated by reference herein. In a preferred embodiment, the PLC transceiver 24 includes PHY and MAC layers embodied as a combination of hardware and software.

The combination of the broadband apparatus 26, the PLC controller 22, the PLC transceiver 24 and the PLC coupler 26 operate, as known in the art, to control the operation and availability on the power line network 16 of high speed, broadband data communication services, which can include the high speed, broadband access services received at the broadband apparatus 26. For a detailed description of PLC services control and operations, see, for example, the assignee's patent applications referenced above. It is to be understood that, in accordance with the present invention, the PLC system 18 can include any PLC technology capable of achieving high speed, broadband data communications access services over a power line network.

In a preferred embodiment, the PLC head end system 18 equipment is constructed to permit installation within the physical housing containing the plant 12 power generating and distribution equipment without requiring substantial modification to the existing physical configuration of the power generating and distribution equipment and the plant housing itself. In a further preferred embodiment, the PLC head end system 18 equipment is constructed to permit installation within enclosure structures associated with electric power generation and distribution that already exist within the plant 12. The installation of the PLC and power generating equipment at the same location, and the simultaneous use of power generating equipment enclosure structures already existing within the plant to contain both PLC and power generating equipment, advantageously reduces installation, equipment and maintenance costs and provides for increased equipment safety, site security, theft prevention, environmental protection, etc. for a combined electric power generating and distribution and broadband access services system.

Referring to FIG. 3, the PLC gateway 54 is a conventional PLC transceiver and signal processing device, such as described in detail in the assignee's patent applications referenced above. In a preferred embodiment, the PLC gateway 54 is plugged into an electrical outlet of the network 16 located within the user facility 14A to establish a PLC connection with the power line network 16. The user PLC gateway 54 provides for and controls high speed, broadband data signal transmission between the user facility 14A and the power plant 12, such that high speed, broadband data communications access services on the power line network 16 can be accessed at the user facility 14A. The PLC gateway 54 can be included, for example, in a component of an in-home PLC network, Ethernet, HPNA or like communication network, or in a power line to wireless bridge.

In a preferred embodiment, the power line network 16 is connected to the user facilities 14 in a complex network configuration including repeater units and bypass units, such as described in the assignee's patent applications referred to above.

The PLC based power demand meter 56 is any known PLC communication device that further can operate to receive electronic data signals representative of power consumption from the conventional, prior art electronic power meter 55 and store such power consumption data in an internal memory (not shown). In a preferred embodiment, the PLC meter 56 is incorporated within the PLC gateway 59.

Referring again to FIG. 2, the MCC 36 includes electronic data signal input ports (not shown) for receiving electronic data signals representative of plant operating status information. Sensors associated with various mechanical components within the power generator system 20 generate and transmit to the MCC 36 electronic data signals representative of conditions being monitored within the system 20. In addition, conventional electronic detectors or sensors 39, such as video cameras or temperature detectors strategically located throughout the plant 12, generate and transmit to the MCC 36 electronic data signals, such as video images, representative of environmental conditions that the sensors 39 monitor throughout the plant 12. The processor 38 of the MCC 36 extracts the sensor data from such received electronic data signals and stores in the memory 40 the sensor data with indexing information, such as time received at the MCC 36 and the identity of the sensor that transmitted the data. The processor 38 of the MCC 36 stores such sensor data in the memory 40.

Referring to FIGS. 1-3, the power plant 12 supplies both electric power and high speed, broadband access services to the electric power user facilities 14 over the power line network 16. The PLC head end system 18 receives high speed, broadband communication signals from an external source, such as a satellite broadband access service provider, at the broadband connection apparatus 26. The broadband apparatus 26 converts the received carrier signals into electrical data signals, which are then forwarded to the PLC controller 22. The PLC controller 22, the PLC transceiver and the PLC coupler 28 operate, as well known in the art, to place the high speed, broadband data signals onto the power line network 16 so that they are received at the appropriate PLC gateway destination at a user facility 14.

The PLC gateway 54 at the user facility 14 receives and processes the PLC data communications signals transmitted from the plant 12 and routes the data to the port 59. Further, the gateway 54 receives data provided by a user at the port 59 and generates and transmits onto the PLC network 16 at the port 57 high speed, broadband data communications signals having destination information, such as a worldwide web or email address, corresponding to a physical location that is far from the small community. Upon receipt at the plant 12 of the high speed, broadband data communications signals transmitted over the power line network 16 by the PLC gateway 54, the PLC coupler, 28, the PLC transceiver 24 and the PLC controller 22 operate together to generate and transmit a corresponding high speed, broadband electrical data signal. The broadband apparatus 26 then generates a carrier signal modulated by the high speed, broadband electrical data signal and then transmits the modulated carrier signal, such as an RF signal, over the high speed, broadband network coupled to the plant 12 at the broadband apparatus 26.

In a preferred embodiment, the PLC controller 22 automatically, at predetermined time intervals, causes the PLC transceiver 24 to generate and transmit over the power line network 16, via the PLC coupler 28, power consumption request data signals for receipt at the PLC gateway 54 of each of the user facilities 14. Upon receipt of such data signals, each of the PLC gateways 54 retrieves the power consumption data stored at the PLC meter 56 within the user facility. The PLC gateways 54 then transmit data communications signals representative of the power consumption data and the identity of the source user facility to the plant 12 over the power line network 16. The PLC components 28, 24 and 22 receive and process the power consumption data signals to extract the power consumption data and then the processor 27 stores such data in the memory 25.

Operational costs of the power generating system 10 are substantially reduced because individualized power consumption data is transmitted to the power plant 12 automatically over the power line network 16 using the PLC functionality of the power generating system 10. The user power consumption data, therefore, is collected and stored at the power plant 12 and then subsequently, on demand or automatically, transmitted to a central billing office via the broadband connection apparatus 26.

In a further preferred embodiment, the processor 27 of the PLC controller 22 monitors use of the broadband access services by individual user facilities 14, based on data communications signals received at and transmitted from the PLC transceiver 24, and stores in the memory 25 data representative of broadband access service indexed by user facility.

In another preferred embodiment, the MCC 36 automatically stores in the memory 40 sensor data transmitted from the sensors 39 and from the electronic monitoring equipment within the power generating system 20.

In still another preferred embodiment, referring to FIG. 2, the power line fault detection equipment 42 coupled to the power line network 16 is advantageously used to detect and identify existing and potential future faults in the network 16. This fault detection capability provides cost savings to the plant owner by avoiding or minimizing loss of revenue based the times that services are not provided. The MCC 36 preferably controls operations of the fault equipment 42, which can include a conventional optical time domain reflectometery or Doppler system.

In a preferred embodiment, the fault equipment 42 includes suitable PLC technology components that are utilized to detect the presence of high frequency harmonics on the network 16. See U.S. patent application Ser. No. 09/605,064, U.S. patent application Ser. No. 09/290,353, and U.S. Provisional Patent Application No. 60/113,608, filed Dec. 23, 1998, each of which is assigned to the assignee of this application and incorporated by reference herein, which concern monitoring power line network characteristics using PLC components and transmitting communication signals over the PLC network to measure changes in network impedance and to identify the locations in the networks causing such changes. In one embodiment, the PLC fault detection equipment transmits communication signals onto the power line network and analyzes network signal response to determine, for example, the presence of illegal power line taps in the network. In addition, the fault equipment 42 evaluates power line network characteristics, such as the presence of high frequency artifacts, with respect to power consumption data to determine whether a certain location in the power line network is undergoing stress, such as may be caused if a tree limb falls on a power transmission wire within the network. See U.S. Pat. Nos. 6,496,342; 6,529,135; 6,453,248; 6,433,978; 6,421,618; 6,393,373; 6,326,796 and 6,199,018, incorporated by reference herein. The detection equipment 42 suitably transmits fault detection data to the MCC 36, which is stored in the memory 40.

In a further embodiment, the fault equipment 42 is included in a PLC network monitoring and quality assessment device which is coupled to a selected electric power distribution element, such as a transformer or power transmission line, of the microgrid. In this embodiment, the fault equipment performs power network monitoring and quality assessment functions to collect information that may be used to diagnose equipment failure or malfunction at elements in the power generating system.

In a preferred embodiment, the PLC controller 22 automatically generates, at predetermined intervals, electrical data signals based on at least one of the power consumption data, broadband access utilization data, fault detection data, and plant operating status data stored in the memories 25 or 40, and transmits these data signals to the broadband apparatus 26. The broadband apparatus 26, in turn, transmits such data signals on a high speed, broadband communication signal to the website or email address of, for example, the power plant owner.

In a further embodiment, the PLC controller 22 is suitably programmed to receive and take action based on data requests and plant control instructions received on a broadband communications signal that is transmitted to the plant 12 from a distant external source, for example, an Internet user that is located far from the isolated community in which the system 20 is found. In response to a data request, the PLC controller 27 can perform such operations as causing the transmission of stored plant operating data, or real time data signals obtained from the sensors 39, such as video signals provided by a video camera, to the requester via the broadband apparatus 26. In addition, the PLC controller 27 can adjust electronic controls or operating procedures associated with any of the components electronically linked to or within the PLC system 18, such as the power generating system 20, the sensors 39 and the PLC demand meter 56, based on instructions received at the broadband apparatus 26. Advantageously, the service provide can obtain stored energy billing information stored at the memory 25 at any time, and regardless of whether the power line network 16 is experiencing a mechanical failure at the time of a request.

Hence, the addition of the PLC functionality to the plant 12 permits remote monitoring of plant operational status and remote control of plant operations. This added remote monitoring and control functionality avoids the expenses associated with having personnel stationed at or periodically visit the remote plant to perform tasks that can be otherwise controlled electronically from a remote location.

In addition, the PLC functionality at the plant 12 advantageously permits substantially real time monitoring of the security conditions with relative ease and at low cost. In a preferred embodiment, the PLC system 18 transmits data signals representative of on-site security conditions, such as video or audio data signals or combinations thereof generated by a video camera sensor 39, directly to a remote location, such as the service provider's home office or a remote central management office of the power plant. On site security for the plant 12, therefore, is effected in a low cost manner and for less cost than presently expended.

In a further preferred embodiment, a personal computer terminal including a display (not shown) is installed within the plant 12 and electronically coupled to the PLC controller 22 to provide, as well known in the art, that stored or real time security or plant operation data or customer usage data can be retrieved and displayed at the computer.

In a further preferred embodiment, a user facility includes a PLC network, which further eases user access to the broadband services. Consequently, the user, simply by plugging in the power cord of a user PLC gateway device, which may be included within a personal computer or multimedia system, into a conveniently located electrical outlet within the facility, easily and simply establishes the necessary physical connection to the power network 16 to obtain high speed, broadband services.

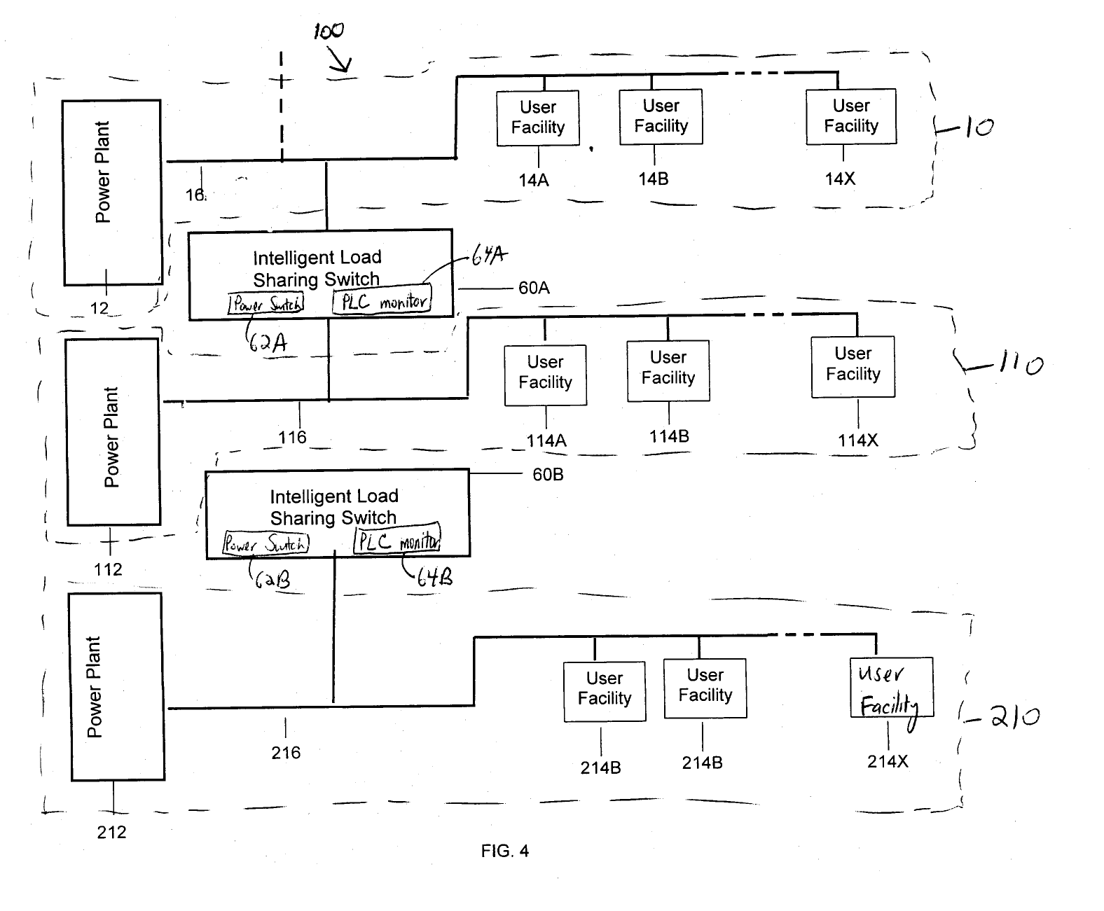

FIG. 4 is preferred embodiment of a large power grid network 100 including the electric power and broadband services system 10 and a plurality of power and broadband service systems 110, 210, etc. which contain power plants 112, 212, etc., user facilities 114, 214, etc. and power line networks 116, 216, etc., respectively. The components of the systems 110, 210, etc. are constructed and operate identically or substantially identically to those described above for the system 10. Referring to FIG. 4, intelligent load sharing switches 60A and 60B interconnect the neighboring microgrid, power line networks 16 and 116, and 116 and 216, to each other, respectively. The switch 60 includes a conventional electric power load sharing connection switch 62 that facilitates switching the power load between the two neighboring microgrids, such as between the networks 16 and 116, as is typically performed in the power generation and distribution industry.

In accordance with the present invention, the switch 60 further includes a PLC network monitoring and bypass apparatus 64. The PLC monitoring/bypass apparatus 64 includes PLC data signal transmission and receiving and data signal processing capabilities similar or identical to those found at the PLC gateway 54, as described above, and PLC bypass equipment, as known in the art, for establishing a PLC connection between the two neighboring microgrids. Therefore, the intelligent switch 60 constitutes a communication interconnect point between the two neighboring power line networks. Although power load sharing requires the switch 62 to establish an electrical connection between two neighboring microgrids, the PLC network monitoring and bypass apparatus 64 permits power line communications to exist constantly between the two microgrids 16 and 116. The continuous presence of PLC signal and data processing capibilites permits that load conditions in neighboring microgrids can be simultaneously monitored, such that the position of the switch 62 can be controlled based on network monitoring performed at the PLC apparatus 64.

In a preferred embodiment, the implementation of power line communications and power distribution in connection with a microgrid, which includes the above-described capabilities of collecting information for controlling power transfer junctions using power line communications functionalities, permits that self-healing power systems and microgrids can be constructed and that sophisticated energy trading options for power distribution networks, such as where a microgrid has the capability to sell energy to or buy energy from a neighboring microgrid in real-time, can be implemented.

Although preferred embodiments of the present invention have been described and illustrated, it will be apparent to those skilled in the art that various modifications may be made without departing from the principles of the invention.

What is claimed is:

1. A system for conveying high speed, broadband data communications signals over a conventional electric power network of an isolated electric power generating system so as to transform the isolated power generating system into a hybrid system having combined electric power generation and broadband access service functionalities, wherein the power generating system comprises an electrical power generating plant having an output coupled to the conventional electric power network and wherein the data communications system, the data communications system comprising:
a high speed, broadband data power line communications (“PLC”) head end system comprising:
a PLC transceiver for receiving and transmitting high speed, broadband data signals;
a PLC power coupler for coupling to an isolated electric power network and coupled to the PLC transceiver, wherein the PLC coupler effects transfer of high speed, broadband data communications signals between the PLC transceiver and the isolated electric power network; and
a broadband uplink connection apparatus for coupling to an external broadband network and coupled to the PLC transceiver, wherein the broadband apparatus facilitates high speed, broadband data communication signals exchange between the PLC transceiver and the external network.

2. The system of claim 1, wherein the PLC transceiver transmits high speed broadband data communications signals representative of data stored within a memory to the broadband connection apparatus based on broadband data communication request data signals received at the broadband connection apparatus from the external broadband network.

3. The system of claim 1, wherein the PLC transceiver automatically transmits high speed, broadband data communications signals representative of data stored within a memory of the PLC head end system to the broadband connection apparatus.

4. The system of claim 1, wherein the PLC head end system further comprises:
a monitoring, command and control apparatus (“MMC”) coupled to the PLC transceiver, wherein the MCC collects and stores in a memory power plant operating and security data transmitted to the MCC from detectors located within the power generating plant.

5. The system of claim 4, wherein the head end PLC transceiver generates and transmits to the broadband apparatus high speed, broadband communications data signals containing at least a portion of the data stored in the memory of the MCC.

6. The system of claim 1 further comprising:
at least one user PLC gateway transceiver for coupling to the power network, wherein the user PLC transceiver includes a PLC power demand meter for receiving power consumption data from an electronic power meter, wherein the user PLC transceiver generates and transmits over the power network to the head end PLC transceiver high speed, broadband power consumption data communications signals representative of the power consumption data.

7. The system in claim 1 further comprising:
at least one PLC gateway transceiver for coupling to the power network and including a power line to wireless bridge for creating a hot-spot wireless implementation.

8. The system of claim 6, wherein the power consumption data is stored in a memory in the PLC head end system and wherein the head end PLC transceiver generates and transmits to the broadband connection apparatus high speed, broadband communications data signals containing the power consumption data stored in the memory.

9. The system of claim 1, wherein the PLC head end system monitors transfer of high speed, broadband data signals over the second data line and generates and stores data representative of the transfer in a memory.

10. The system of claim 6, wherein the head end PLC transceiver generates and transmits to the broadband apparatus high speed, broadband communications data signals representative of the high speed signal transfer data.

11. The system of claim 1 further comprising network fault detection apparatus for detecting and identifying the location of an actual or potential fault in the power line network, wherein the fault detection apparatus is coupled to the power line network.

12. The system of claim 11, wherein the fault detection apparatus transmits PLC data signals onto the network to detect and identify the location of the faults.

13. The system of claim 12, wherein the fault detection apparatus processes detected high frequency PLC network artifacts to identify the presence and location of a fault in the network.

14. The system of claim 1 further comprising:
a PLC network monitoring and assessment apparatus for coupling to the power network, wherein the PLC network monitoring and assessment apparatus includes a PLC gateway transceiver for performing PLC data communications signal processing and network monitoring and quality assessment functions at the physical layer interface.

15. The system of claim 1 further comprising:
a PLC gateway transceiver for coupling to the power line network and receiving PLC power consumption control data signals transmitted from the PLC head end system, wherein the PLC consumption control data includes instructions for controlling and optimizing power consumption within the power line network.

16. The system in claim 1 further comprising:
an intelligent power load sharing and PLC switch for coupling to at least two neighboring power line networks, wherein the power load sharing and PLC switch provides for transfer of electric power between the neighboring microgrids, and wherein the power load sharing and PLC switch provides for power line communications between the neighboring microgrids regardless of whether energy is being transferred between the neighboring microgrids.

17. The system of claim 1, wherein the power plant is contained within a housing having a predetermined physical configuration, wherein the PLC head end system is constructed to permit installation within the housing of the power plant without requiring substantial modification to the physical configuration of the housing.

18. The system of claim 17, wherein the plant housing includes at least one enclosure structure containing power generating equipment, wherein the PLC head end system is constructed to permit installation within at least one of the power generating equipment enclosure structures.
